(19) United States
(12) Patent Application Publication
(10) Pub. No.: US 2016/0137552 A1
(43) Pub. Date: May 19, 2016

(54) REACTION RESIN MORTAR, MULTI-COMPONENT MORTAR SYSTEM AND THE USE THEREOF

(71) Applicant: Hilti Aktiengesellschaft, Schaan (LI)

(72) Inventors: Thomas Burgel, Landsberg (DE); Monika Monch, Landsberg/Lech (DE)

(21) Appl. No.: 15/003,276

(22) Filed: Jan. 21, 2016

Related U.S. Application Data
(63) Continuation of application No. PCT/EP2014/065803, filed on Jul. 23, 2014.

(30) Foreign Application Priority Data
Jul. 24, 2013 (EP) 13177785.6

(51) Int. Cl. C04B 26/06; E21B 33/13; C04B 24/00

(52) U.S. Cl. CPC C04B 26/06; C04B 24/008; E21B 33/13; C04B 2111/00715

(57) ABSTRACT

A reaction resin mortar comprising a resin mixture is described, that contains at least one radically polymerizable compound, at least one reactive diluent and at least one inhibitor, whereby the viscosity of the resin mixture is set to a particular value, a two-component or multi-component mortar system and the use thereof for construction purposes, in particular for chemical anchoring in mineral substrates.

### RELATED APPLICATIONS

This application claims priority to, and is a continuation of, International Application No. PCT/EP2014/065803 having an International filing date of Jul. 23, 2014, which is incorporated herein by reference, and which claims priority to European Patent Application No. 13177785.6, having a filing date of Jul. 24, 2013, which is also incorporated herein by reference] in its entirety.

### SUMMARY OF THE TECHNOLOGY

The present invention concerns a reaction resin mortar comprising a resin mixture containing at least one radically polymerizable compound, at least one reactive diluent and at least one polymerization inhibitor, whereby the resin mixture is set to a specific viscosity, a two- or multi-component mortar system containing the reaction resin mortar, as well as its use for construction purposes, in particular for chemical anchoring.

### BACKGROUND OF THE INVENTION

Two-component mortar compounds with a curable resin component containing at least one radically polymerizable resin, fillers, accelerators, stabilizers and optionally other conventional mortar components, as well as a curing component disposed separately to inhibit reaction and containing at least one peroxide, and their use for construction purposes, are well-known.

Two-component mortar compounds of this type are used, for example, as an injection mortar for the chemical anchoring of fastening elements, preferably metal elements, in a variety of substrates, preferably mineral substrates, such as in particular structures made of brickwork, concrete or natural stone. The boreholes needed to secure the anchoring means are drilled into the mineral substrate first. Then the curable resin component is mixed with the curing agent component of the two-component mortar compound and introduced into the borehole, whereupon the anchoring means that is to be secured is inserted and adjusted, and the mortar compound is cured. For this the applicant sells injection mortars in the form of fast-curing systems, with a hybrid system consisting of a radical curing methacrylate resin and a hydraulically-setting cement, which, after processing in the borehole, yields an extremely resilient plastic.

For injection mortars for chemical anchoring of anchoring elements in boreholes, the mortar compounds are typically identified either as a universal mortar or the mortar compound is formulated specifically for the substrate. Identification as a universal mortar means that the mortar compound is suited for all mineral substrates, in general concrete, masonry (solid brick or solid masonry), hollow masonry (hollow bricks or perforated brick masonry), lightweight or porous concrete and the like, whereby the load values for the respective substrates vary greatly. If the mortar compounds are tailored for use in specific substrates, it means that the mortar compounds are formulated very specifically for use in a certain type of substrate, are thereby optimized and thus yield better load values for the respective use. Examples of a commercially available, universally applicable injection mortar are the products Hilti HIT-HY 70 injection mortar and Hilti HFX injection mortar. Hilti HIT-HY 150 MAX for use in concrete and Hilti HIT-ICE injection mortar for substrate temperatures to −18 C can be mentioned as examples of specifically formulated mortar compounds.

It has been found that, particularly in solid brick, the performance of most mortar compounds, most notably the universally formulated mortar compounds, is limited and strongly dependent on the substrate temperature.

In the development of a non-labeled product, similar to the mortar compound described in DE 10 2010 051 818 B3, specifically for use in masonry, it was shown that the polymerization inhibitors, such as catechol or 4-tert-butylcatechol (EP 1 935 860 A1), identified to date as particularly high-performance, do not lead to the expected moderate-good level of performance. With the named polymerization inhibitors, it was possible to achieve only very small load values that are not adequate for many applications, in particular applications that require high load values. Even the use of the reactive diluents known specifically for application in bricks, namely hydroxyalkyl(meth)acrylates, such as hydroxypropyl methacrylate (DE 10 2004 035 567 A1), or acetoacetoxy-alkyl(meth)acrylates, such as acetoacetoxyethyl methacrylate (DE 41 31 457 A1), combinations thereof (DE 10 2004 035 567 B4), or the addition of alkyl(meth)acrylates (DE 10 2009 043 792 A1), could not significantly improve performance.

Consequently, there is a need for a high-performance mortar compound for use in or on masonry, in particular brick substrates, that provides better load values than the currently available injection mortars.

It is therefore the task of the invention to provide a reaction resin mortar with improved performance when used in mineral substrates, in particular masonry.

### BRIEF SUMMARY OF THE INVENTION

Surprisingly, the inventors discovered that the viscosity of the resin mixture has a significant effect on the performance of a mortar compound. The load values increase with increasing viscosity, whereby the effect of the viscosity is limited by the fact that the compounds have to still be workable after the two- or multi-component system has been formulated. It must in particular be possible to still be able to apply the compounds with a manual dispenser.

One embodiment of the present reaction resin mortar comprises a resin mixture, which contains at least one radically curable compound, at least one reactive diluent and at least one inhibitor, and at least one inorganic and/or organic aggregate, characterized in that the resin mixture has a viscosity in the range between 200 and 800 mPa-s, measured according to DIN EN ISO 2884 at 23° C.

The at least one reactive diluent can be selected from 1,3-dicarbonyl compounds of the general Formula (I)

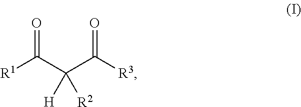

in which

R¹ is a straight-chain or branched, optionally substituted, C₁-C₆-alkyl group, preferably a C₁-C₂-alkyl group;

R³ is hydrogen or a straight-chain or branched, optionally substituted, C₁-C₆-alkyl group, a C₁-C6-alkoxy group or a methacryloyloxy of the Formula (II)

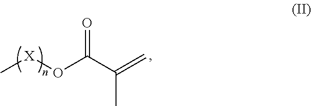

in which X is a methylene, ethylene glycol or propylene glycol group, and n is a whole number with a value from 1 up to and including 6;

R² is hydrogen, a straight-chain or branched, likewise substituted, C₁-C₆-alkyl group or a C₁-C6-alkoxy group, or together with R³ forms an optionally substituted, five- or six-membered aliphatic ring, which optionally comprises heteroatoms in or on the ring;

or of the general Formula (III)

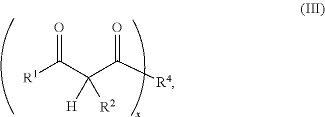

in which

R⁴ is a di- or polyhydric alcohol

x is a number between 1 and 6, and

R¹ and R² are as defined above.

For example, the at least one reactive diluent can be selected from the group consisting of acetylacetone, 2-(acetoacetoxy)ethyl methacrylate, tri methylolpropane triacetoacetate, benzyl acetoacetate, α-acetyl-γ-butyrolactone, tert-butyl acetoacetate and ethyl acetoacetate. The at least one reactive diluent can be contained in a quantity from 1 to 15 wt %.

The at least one inhibitor can be selected from among the stable N-oxyl radicals or 4-hydroxy-3,5-di-tert- butyltoluenes. For example, the inhibitor can be selected from the group consisting of piperidinyl-N-oxyl-, tetrahydropyrrole-N-oxyl-, indoline-N-oxyl-, B-phosphorylated N-oxyl radicals and 4-hydroxy-3,5-di-tert-butyltoluene. The at least one inhibitor can be contained in a quantity from 0.005 to 2 wt %.

In one embodiment, the ratio of the at least one 1,3-dicarbonyl compound and the at least one N-oxyl radical or 4-hydroxy-3,5 di-tert-butyltoluene is between 30:1 and 150:1.

The radically polymerizable compound can be an unsaturated polyester resin, a vinyl ester resin, a urethane(meth)acrylate resin and/or an epoxy(meth)acrylate resin.

The aggregate can be an inorganic filler selected from the group consisting of quartz, sand, fumed silica, corundum, chalk, talc, ceramic, alumina, glass, cement, light spar and/or heavy spar in a suitable particle size distribution, or combinations thereof. As another example, the aggregate can be a thickening agent selected from the group consisting of fumed silicas, phyllosilicates, acrylate or polyurethane thickeners, castor oil derivatives, Neuburg Siliceous Earth and xanthan gum, or combinations thereof.

The reaction resin mortars of the invention can be used to make a two- or multi-component mortar system by combining with a curing agent such that the curing agent and inorganic and/or organic aggregates are separated to inhibit reaction.

The curing agent can be an inorganic or organic peroxide.

The two- or multi- component mortar system can contain an accelerator. In one embodiment, the accelerator is contained in a quantity between 0.1 to 1.5 wt %, the inhibitor is contained in a quantity between 0.003 to 0.35 wt % and the curing agent is contained in a quantity between 0.1 to 3 wt %, based respectively on the total weight of the two- or multi-component mortar system. In another embodiment, the accelerator is contained in a quantity between 0.1 to 0.5 wt %, the inhibitor is contained in a quantity between 0.003 to 0.07 wt % and the curing agent is contained in a quantity between 0.1 to 0.35 wt %, based respectively on the total weight of the two- or multi-component mortar system.

The reaction resin mortars or two- or multi-component mortar systems of the invention can be used for construction purposes, such as for chemical securing of fastening elements and/or anchoring means in boreholes in mineral substrates.

### BRIEF DESCRIPTION OF SEVERAL VIEWS OF THE DRAWINGS

Not Applicable

### DETAILED DESCRIPTION OF THE INVENTION

To better understand the invention, we believe the following explanations of the terminology used herein to be useful. In the sense of the invention:

“resin mixture” is a mixture consisting of the reaction mixture of the preparation of the resin, containing the radically polymerizable compound, optionally a catalyst for the preparation of the compound, reactive diluents, and stabilizers, and, if necessary, accelerators and additional reactive diluents;

“reaction resin mortar” is a mixture consisting of the resin mixture and inorganic and/or organic aggregates;

“curing agents” are substances that effect the polymerization reaction (curing) of the base resin;

“curing agent” is a mixture consisting of the curing agent and inorganic and/or organic aggregates;

“accelerator” is a compound capable of accelerating the polymerization reaction (curing), which serves to accelerate the formation of the radical initiator;

“polymerization inhibitor”, herein also synonymously referred to in shortened form as “inhibitor”, is a compound capable of inhibiting the polymerization reaction (curing), which serves to prevent the occurrence of the polymerization reaction, and with it an undesired premature polymerization of the radically polymerizable compound during storage (often referred to as a stabilizer), and which serves to delay the start of the polymerization reaction immediately after the addition of the curing agent; to achieve the objective of storage stability, the inhibitor is typically used in such small quantities that the gel time is not affected; to affect the time of the start of the polymerization reaction, the inhibitor is typically used in quantities that do not affect the gel time;

“reactive diluents” are liquid or low-viscosity radically polymerizable compounds, which dilute the resin mixture, thereby giving them the viscosity required for their application, contain functional groups capable of reacting with the base resin and, during polymerization (curing), for the most part become a component of the cured composition (mortar);

“Mortar compound' is the formulation that is obtained by mixing the reaction resin mortar with the curing agent, and that can as such be directly used for chemical securing;

“two-component system” is a system that comprises two components, generally a resin component and a curing agent component, which are stored separately, so that curing of the reaction resin mortar does not occur until after the mixing of the two components;

“multi-component system” is a system that comprises three or more components, which are stored separately, so that curing of the reaction resin mortar does not occur until after the mixing of the all the components;

“gel time” is the duration of the curing phase of the resin, in which the temperature of the resin increases from +25° C. to +35° C.; this roughly corresponds to the period in which the fluidity or viscosity of the resin is still in a range in which the reaction resin or the reaction resin compound can still easily be handled or worked;

“(meth)acryl . . . /. . . (meth)acryl . . . ” means that both the “methacryl . . . /. . . methacryl . . . ”-compounds as well as the “acryl . . . /. . . acryl . . . ”-compounds are intended to be included.

The inventors surprisingly discovered that the performance of a mortar compound in masonry, in particular in the brick can be increased significantly with a resin mixture, the viscosity of which is set between 200 and 800 mPa-s, preferably between 300 and 500 mPa-s, measured, in accordance with DIN EN ISO 2884, with a rheometer RS 600 of the Company Haake, Karlsruhe; measurement geometry cone and plate φ 60 mm, 1° titanium (C60/1° Ti), gap 0.052 mm at 23° C. and a shear rate of 150 s⁻¹.

A first subject matter of the invention is therefore a reaction resin mortar, comprising a resin mixture containing at least one radically polymerizable compound, at least one reactive diluent and at least one inhibitor, and organic and/or inorganic aggregates, which is characterized in that the resin mixture has a viscosity in the range between 200 and 800 mPa-s, preferably between 300 and 500 mPa-s, measured in accordance with DIN EN ISO 2884 at 23° C.

To adjust the viscosity of the resin mixture, the resin mixture contains solvents. The solvents can be inert vis-à-vis the reaction system, or, which is preferred, be so-called reactive diluents and participate in the polymerization during curing.

The reactive diluents can be added in quantities of 90 to 10 wt %, preferably 70 to 30 wt %, with reference to the resin mixture, whereby the amount is selected so that the resin mixture is set to the desired viscosity.

Suitable reactive diluents are described in EP 1 935 860 A1 and DE 195 31 649 A1. As a reactive diluent the resin mixture preferably contains a (meth)acrylic acid ester, whereby the (meth)acrylic acid esters are particularly preferably selected from the group consisting of hydroxypropyl(meth)acrylate, propanediol-1,3-di(meth)acrylate, butanediol-1,3-di(meth)acrylate, trimethylolpropane tri(meth)acrylate, 2-ethylhexyl(meth)acrylate, phenylethyl(meth)acrylate, tetrahydrofurfuryl(meth)acrylate, ethyl triglycol(meth)acrylate, N,N-dimethylaminoethyl(meth)acrylate, N,N-dimethylaminomethyl(meth)acrylate, butanediol-1,4-di(meth)acrylate, acetoacetoxyethyl (meth)acrylate, ethanediol-1,2-di(meth)acrylate, isobornyl(meth)acrylate, diethylene glycol di(meth)acrylate, methoxy polyethylene glycol mono(meth)acrylate, trimethylcyclohexyl(meth)acrylate, 2-hydroxyethyl(meth)acrylate, dicyclopentenyl oxyethyl(meth)acrylate and/or tricyclopentadienyldi(meth)acrylate, bisphenol-A-(meth)acrylate, novolac epoxy di(meth)acrylate, di-[(meth)acryloyl-maleoyl]-tricyclo-5.2.1.0²⁶-decane, dicyclopentenyl oxyethyl crotonate, 3-(meth)acryloyl-oxymethyl-tricylo-5.2.1.0²⁶-decane, 3-(meth)cyclopentadienyl(meth)acrylate, isobornyl(meth)acrylate, and decalyl-2-(meth)acrylate.

Other common radically polymerizable compounds can in principle also be used, alone or in a mixture with the (meth)acrylic acid esters e.g. styrene, α-methylstyrene (2-phenyl-1-propene), alkylated styrenes, such as tert-butylstyrene, divinylbenzene and allyl compounds.

The inventors were further able to discover that the selection of the reactive diluent has an additional positive impact on the performance, in particular on the failure loads in the brick.

Unexpectedly and surprisingly it became evident that the performance of a reaction resin mortar compound in the brick can be further increased when 1,3-dicarbonyl compounds are used as reactive diluents.

Therefore, in a further preferred embodiment, the reactive diluent is selected from 1,3-dicarbonyl compounds of the general Formula (I)

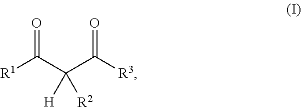

in which

R¹ is a straight-chain or branched, optionally substituted, C₁-C₆-alkyl group, preferably a C₁-C₂-alkyl group;

R³ is hydrogen or a straight-chain or branched, optionally substituted, C₁-C₆-alkyl group, preferably a C₁-C₂-alkyl group, or a C₁-C₆-alkoxy group, preferably a C₁-C₂-alkoxy group, or a methacryloyloxy of the Formula (II)

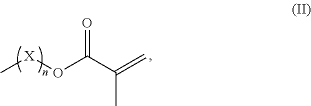

in which X is a methylene, ethylene glycol or propylene glycol group, and n is a whole number with a value from 1 up to and including 6, preferably 1 up to and including 3;

R² is hydrogen, a straight-chain or branched, optionally substituted, C₁-C₆-alkyl group preferably a C₁-C₂-alkyl group, or a C₁-C6-alkoxy group preferably a C₁-C₂-alkyl group, or together with R³ forms an optionally substituted, five- or six-membered aliphatic ring, which optionally comprises heteroatoms in or on the ring;

or of the general Formula (III)

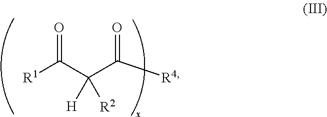

in which

R⁴ is a di- or polyhydric alcohol (in the following also referred to as a polyol compound)

x is a number between 1 and 6, and

R¹ and R² have the same meaning as defined above, whereby R¹ particularly preferably is a methyl group and R² particularly preferably is hydrogen.

Suitable di- or polyhydric alcohols include, for example, alkanediols, alkylene glycols such as ethylene glycol and propylene glycol, glycerols, sugars, pentaerythritols, polyhydric derivatives or mixtures thereof. Some examples of di- or polyhydric alcohols are neopentyl glycol, trimethylolpropane, ethylene glycol and polyethylene glycol, propylene glycol and polypropylene glycol, butanediol, pentanediol, hexanediol, tricyclodecane dimethylol, 2,2,4-trimethyl-1,3-pentanediol, bisphenol A, cyclohexanedimethanol, castor oil as well as their alkoxylated and/or propoxylated derivatives.

In another embodiment of the invention, the compound of the Formula (III) is selected from acetoacetates of optionally once or multiply ethoxylated and propoxylated diols, triols and polyols, such as ethylene glycol monoacetoacetate, ethylene glycol diacetoacetate, 1,2-propanediol monoacetoacetate, 1,2-propanediol diacetoacetate, 1,3-propanediol monoacetoacetate, 1,3-propanediol diacetoacetate, 1,4-butanediol monoacetoacetate, 1,4-butanediol diacetoacetate, 1,6-hexanediol monoacetoacetate, 1,6-hexanediol diacetoacetate, neopentyl glycol monoacetoacetate, neopentyl glycol diacetoacetate, trimethylolpropane monoacetoacetate, trimethylolpropane diacetoacetate or trimethylolpropane triacetoacetate, glycerol monoacetoacetate, glycerol diacetoacetate, glycerol triacetoacetate, pentaerythritol tetraacetoacetate, pentaerythritol monoacetoacetate, pentaerythritol diacetoacetate, pentaerythritol triacetoacetate, pentaerythritol tetraacetoacetate, dipentaerythritol monoacetoacetate, dipentaerythritol diacetoacetate, dipentaerythritol triacetoacetate, dipentaerythritol tetraacetoacetate, dipentaerythritol pentaacetoacetate or dipentaerythritol hexaacetoacetate.

In one embodiment, the compound of Formula (I) is a compound of Formula (IV)

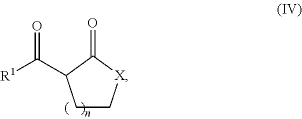

in which n is 1, 2 or 3, preferably 1 or 2, and X represents O, S, or NR⁵, preferably O, whereby R⁵ is hydrogen or a, optionally substituted, alkyl, cycloalkyl, aryl or aralkyl group.

Preferably in Formula (IV), n is 1, X is 0 and R¹ is OR⁶, whereby R⁶ is an optionally substituted alkyl group, particularly preferably a methyl group. Most especially preferred, the compound of the Formula (IV) is α-acetyl-γ-butyrolactone (ABL).

In a particularly preferred embodiment of the invention, the at least one reactive diluent is selected from the group consisting of acetylacetone, 2-(acetoacetoxy)ethyl methacrylate, triacetoacetate trimethylolpropane, benzylacetoacetate, α-acetyl-γ-butyrolactone, tent-butyl acetoacetate and ethyl acetoacetate.

The 1, 3-dicarbonyl compounds can be used alone or as a mixture.

The 1,3-dicarbonyl compound is preferably added to the resin mixture in quantities between 1 and 15 wt %, more preferably between 6 and 10 wt %.

Inhibitors, such as phenolic compounds and non-phenolic compounds that are commonly used for radically polymerizable compounds, and are well-known to a person skilled in the art, are suitable for use as inhibitors here.

Possible phenolic inhibitors, which are often a component of commercial radical curing reactive resins, are phenols such as 2-methoxyphenol, 4-methoxyphenol, 2,6-di-tert-butyl-4-methylphenol, 2,4-di-tert-butylphenol, 2,6-di-tert-butylphenol, 2,4,6-trimethylphenol, 2,4,6-tris(dimethylaminomethyl)phenol, 4,4′-thio-bis(3-methyl-6-tert-butylphenol), 4,4′-isopropylidenediphenol, 6,6′-di-tert-butyl-4,4′-bis(2,6-di-tert-butylphenol), 1,3,5-trimethyl-2,4,6-tris(3,5-di-tert-butyl-4-hydroxybenzyl)benzene, 2,2′-methylene-di-p-cresol, catechol and butylcatechols such as 4-tert-butylcatechol, 4,6-di-tert-butylcatechol, hydroquinones such as hydroquinone, 2-methylhydroquinone, 2-tert-butylhydroquinone, 2,5-di-tert-butylhydroquinone, 2,6-di-tert-butylhydroquinone, 2,6-dimethylhydroquinone, 2,3,5-trimethylhydroquinone, benzoquinone, 2,3,5,6-tetrachloro-1,4-benzoquinone, methyl benzoquinone, 2,6-dimethylbenzoquinone, naphthoquinone, or mixtures of two or more thereof.

Possible non-phenolic inhibitors are preferably phenothiazines such as phenothiazine and/or derivatives or combinations thereof.

Substituted pyrimidinol or pyridinol compounds, as they are described in DE 10 2011 077 248 B1, can also be used as inhibitors in the para position to the hydroxyl group.

Surprisingly, it has been shown that, independent of the choice of the reactive diluent, the efficiency of a reaction resin mortar compound in the brick can also be increased by using at least one stable N-oxyl radical or 4-hydroxy-3,5-di-tert-butyltoluene as an inhibitor. In addition, the resin mixture can also contain small amounts of other above-mentioned inhibitors, primarily for the storage stability of the radically polymerizable compound, and thus of the resin mixture, as well as the reaction resin mortar in which it is contained. These can either be introduced by the manufacturing of the radically polymerizable compound or by the reactive diluents, or are added in the course of the formulation of the resin mixture.

In another preferred embodiment of the invention, the inhibitor is consequently selected from stable N-oxyl radicals or 4-hydroxy-3,5-di-tert-butyltoluene.

According to the invention, N-oxyl radicals such as those described in DE 199 56 509 A1 can be used here as the N-oxyl radicals (herein also synonymously referred to as nitroxyl radicals). Suitable stable N-oxyl radicals can be selected from 1-oxyl-2,2,6,6-tetramethylpiperidine, 1-oxyl-2,2,6,6-tetramethylpiperidin-4-ol (also referred to as TEMPOL), 1-oxyl-2,2,6,6-tetramethylpiperidin-4-on (also referred to as TEMPON), 1-oxyl-2,2,6,6-tetramethyl-4-carboxyl-piperidine (also referred to as 4-carboxy-TEMPO), 1-oxyl-2,2,5,5-tetramethylpyrrolidine, 1-oxyl-2,2,5,5-tetramethyl-3-carboxyl pyrrolidine (also referred to as 3-carboxy-PROXYL), aluminum-N-nitrosophenylhydroxylamine and diethylhydroxylamine. Oximes, such as acetaldoxime, acetone oxime, methyl ethyl ketoxime, salicyldoxime, benzoxime, glyoximes, dimethylglyoxime, acetone-O-(benzyloxycarbonyl)oxime, or indoline nitroxyl radicals, such as 2,3-dihydro-2,2-diphenyl-3-(phenylimino)-1H-indol-1 -oxyl nitroxide, or β-phosphorylated nitroxyl radicals, such as 1-(diethoxyphosphinyl)-2,2-dimethylpropyl-1,1-dimethylmethyl-nitroxide, and the like are also suitable nitroxyl radicals. In this context we refer to DE 199 56 509 A1, the content of which is hereby incorporated into this application. The N-oxyl-radicals can be used individually or as a mixture.

In a preferred embodiment of the invention, the polymerization inhibitor is selected from the group consisting of piperidinyl-N-oxyl-, tetrahydropyrrolyl-N-oxyl-,indoline-N-oxyl-, β-phosphorylated N-oxyl radicals and 4-hydroxy-3,5-di-tert-butyltoluene.

The inhibitor is preferably added to the resin mixture in quantities between 0.005 and 2 wt %, more preferably between 0.05 and 1 wt %.

A combination of 1,3-dicarbonyl compound as the reactive diluent and N-oxyl radical or 4-hydroxy-3,5-di-tert-butyl toluene as the inhibitor has proven to be particularly effective in terms of improving the performance of a reaction resin mortar compound in masonry, in particular in the brick.

In a particularly preferred embodiment, the 1,3-dicarbonyl compound in this combination is present in excess with respect to the inhibitor, whereby the weight ratio of the at least one 1,3-dicarbonyl compound to the polymerization inhibitor is between 30:1 to 150:1, preferably 50:1 to 150:1, particularly preferably 75:1 to 135:1. This makes a large increase in performance in the masonry, in particular in the brick, possible.

Ethylenically unsaturated compounds, compounds with carbon-carbon triple bonds and thiol-Yn/En resins, as they are well-known to a person skilled in the art, are suitable as the radical polymerizable compounds according to the invention.

Preferred from among these compounds is the group of ethylenically unsaturated compounds, which includes the styrenes and derivatives thereof, (meth)acrylates, vinyl esters, unsaturated polyesters, vinyl ethers, allyl ethers, itaconates, dicyclopentadiene compounds and unsaturated fats, of which unsaturated polyester resins and vinyl ester resins in particular are suitable, and are described in EP 1 935 860 A1, DE 195 31 649 A1, WO 02/051903 A1 and WO 10/108939 A1, for example. Vinyl ester resins are most preferred because of their hydrolytic resistance and excellent mechanical properties.

Examples of suitable unsaturated polyesters, which can be used in the resin mixture according to the invention, are divided into the following categories, as classified by M. Malik et al. in JMS—Rev. Macromol. Chem. Phys., C40 (2 and 3), p.139-165 (2000):

(1) Ortho-resins: these are based on phthalic anhydride, maleic anhydride or fumaric acid and glycols, such as 1,2-propylene glycol, ethylene glycol, diethylene glycol, triethylene glycol, 1,3-propylene glycol, dipropylene glycol, tripropylene glycol, neopentyl glycol or hydrogenated bisphenol-A;

(2) Iso-resins: these are manufactured from isophthalic acid, maleic anhydride or fumaric acid and glycols. These resins can contain higher proportions of reactive diluents than the ortho-resins;

(3) Bisphenol-A-fumarates: these are based on ethoxylated bisphenol-A and fumaric acid;

(4) HET-acid resins (hexachloro-endo-methylene-tetrahydrophthalic acid resins): resins obtained from anhydrides or phenols containing chlorine/bromine in the manufacturing of unsaturated polyester resins.

In addition to these classes of resins, the so-called dicyclopentadiene resins (DCPD) can also be distinguished as unsaturated polyester resins. The class of DCPD-resins is obtained either by modification of one of the above resin types via the Diels-Alder reaction with cyclopentadiene, or alternatively via a first reaction of a dicarboxylic acid, e.g. maleic acid, with dicyclopentadienyl, followed by a second reaction, the customary manufacturing of an unsaturated polyester resin obtained, whereby the latter is referred to as a DCPD maleate resin.

The unsaturated polyester resin preferably has a molecular weight Mn in the range from 500 to 10,000 daltons, more preferably in the range from 500 to 5000 and still more preferably in the range from 750 to 4000 (in accordance with ISO 13885-1). The unsaturated polyester resin has an acid value in the range 0 to 80 mg KOH/g resin, preferably in the range from 5 to 70 mg KOH/g resin (in accordance with ISO 2114-2000). If a DCPD-resin is used as the unsaturated polyester resin, the preferred acid value is 0 to 50 mg KOH/g resin.

In the sense of the invention, vinyl ester resins are oligomers, prepolymers or polymers with at least one (meth)acrylate end group, so-called (meth)acrylate functionalized resins, which also includes urethane(meth)acrylate resins and epoxy(meth)acrylates.

Vinyl ester resins, which exhibit unsaturated groups only in end position, are obtained, for example, by reacting epoxy oligomers or epoxy polymers (e.g. bisphenol A diglycidyl ether, phenol novolac-type epoxies, or epoxy oligomers based on tetrabromobisphenol A) with (meth)acrylic acid or (meth)acrylamide, for example. Preferred vinyl ester resins are (meth)acrylate functionalized resins and resins obtained by reacting an epoxy oligomer or epoxy polymer with methacrylic acid or methacrylamide, preferably with methacrylic acid. Examples of such compounds are known from the publications U.S. Pat. No. 3,297,745 A, U.S. Pat. No. 3,772,404 A, U.S. Pat. No. 4,618,658 A, GB 2 217 722 A1, DE 37 44 390 A1 and DE 41 31 457 A1.

(Meth)acrylate functionalized resins obtained, for example, by reaction of di- and/or higher functional isocyanates with suitable acrylic compounds, optionally with the assistance of hydroxyl compounds containing at least two hydroxyl groups, as described in DE 3940309 A1 for example, are particularly suitable and preferred as the vinyl ester resin.

Aliphatic (cyclic or linear) and/or aromatic di- or higher functional isocyanates, or prepolymers thereof, can be used as isocyanates. The use of such compounds serves to increase the wetting ability, thus improving the adhesion properties. Preferred are aromatic di- or higher functional isocyanates or prepolymers thereof, whereby aromatic di- or higher functional prepolymers are especially preferred. Examples that can be mentioned are toluene diisocyanate (TDI), diisocyanate diphenylmethane (MDI) and polymeric diisocyanate diphenylmethane (pMDI), to increase chain stiffness, and hexane diisocyanate (HDI) and isophorone diisocyanate (IPDI), which improve flexibility. From among these, polymeric diisocyanate diphenylmethane (pMDI) is very particularly preferred.

Suitable acrylic compounds are acrylic acid and acrylic acids substituted on the hydrocarbon radical, such as methacrylic acid, hydroxyl group-containing esters of acrylic or methacrylic acid with polyhydric alcohols, pentaerythritol tri(meth)acrylate, glycerol di(meth)acrylate, as well as trimethylolpropane di(meth)acrylate, neopentyl glycol mono(meth)acrylate. Preferred are acrylic or methacrylic acid hydroxylalkyl esters, such as hydroxyethyl(meth)acrylate, hydroxypropyl(meth)acrylate, polyoxyethylene(meth)acrylate, polyoxypropylene(meth)acrylate, in particular since such compounds serve to sterically hinder the saponification reaction.

Suitable as optionally usable hydroxyl compounds are di- or polyhydric alcohols, possible derivatives of ethylene- or propylene oxide, such as ethanediol, di- or triethylene glycol, propanediol, dipropylene glycol, other diols such as 1,4-butanediol, 1,6-hexanediol, neopentyl glycol, diethanolamine, further bisphenol A or F or their ethoxylation/propoxylation and/or hydrogenation or halogenation products, polyhydric alcohols, such as glycerol, trimethylolpropane, hexanetriol and pentaerythritol, hydroxyl group-containing polyethers, for example oligomers of aliphatic or aromatic oxiranes and/or higher cyclic ethers, such as ethylene oxide, propylene oxide, styrene oxide and furan, polyethers that contain aromatic structural units in the main chain, such as those of bisphenol A or F, hydroxyl group-containing polyesters based on the above-mentioned alcohols or polyethers and dicarboxylic acids or their anhydrides, such as adipic acid, phthalic acid, tetra- or hexahydrophthalic acid, HET acid, maleic acid, fumaric acid, itaconic acid, sebacic acid and the like. Particularly preferred are hydroxyl compounds containing aromatic structural units to stiffen the chain of the resin, hydroxyl compounds containing unsaturated structural units, such as fumaric acid, to increase the crosslink density, branched or star-shaped hydroxyl compounds, in particular tri- or polyhydric alcohols and/or polyethers or polyesters that contain their structural units, branched or star-shaped urethane(meth)acrylates to achieve lower viscosity of the resins and their solutions in reactive diluents and higher reactivity and crosslink density.

The vinyl ester resin preferably has a molecular weight Mn in the range from 500 to 3000 daltons, more preferably 500 to 1500 daltons (in accordance with ISO 13885-1). The vinyl ester resin has an acid value in the range from 0 to 50 mg KOH/g resin, preferably in the range from 0 to 30 mg KOH/g resin (in accordance with ISO 2114-2000).

All these resins that can be used according to the invention can be modified in accordance with methods familiar to a person skilled in the art to achieve lower acid values, hydroxyl values or anhydride values, for example, or to be made more flexible by the incorporation of flexible units into the basic structure, etc.

The resin can also contain other reactive groups that can be polymerized with a radical initiator, such as a peroxide; for instance reactive groups derived from itaconic acid, citraconic acid, allylic groups, and the like.

According to the invention, in addition to the just described resin mixture, the reaction resin mortar contains inorganic and/or organic aggregates, such as fillers and/or other additives.

The proportion of the resin mixture in the reaction resin mortar is preferably 10 to 70 wt %, more preferably 40 to 60 wt %, with reference to the reaction resin mortar.

Accordingly, the proportion of the aggregates is preferably 90 to 30 wt %, more preferably 60 to 40 wt %, with reference to the reaction resin mortar.

Conventional fillers, preferably mineral or mineral-like fillers, such as quartz, glass, sand, silica sand, quartz powder, porcelain, corundum, ceramic, talc, silica (e.g. fumed silica), silicates, clay, titanium dioxide, chalk, heavy spar, feldspar, basalt, aluminum hydroxide, granite or sandstone, polymeric fillers, such as composite thermosetting plastics, hydraulically curable fillers, such as gypsum, caustic lime or cement (e.g. alumina or Portland cement), metals, such as aluminum, carbon black, as well as wood, mineral or organic fibers, etc., or mixtures of two or more thereof, which can be added as a powder, in granular form or in the form of molded bodies, are used as fillers. The fillers can be present in any form, for instance as a powder or flour or as molded bodies, e.g. in the form of cylinders, rings, spheres, small plates, rods, saddles or crystals, or also in the form of fibers (fibrillar fillers), whereby the corresponding base particles preferably have a maximum diameter of 10 mm. Fillers are preferably present in the respective component in a quantity up to 90, in particular 3 to 85, especially 5 to 70 wt %.

Other possible additives are thixotropic agents, such as optionally organically after-treated fumed silica, bentonites, alkyl and methyl celluloses, castor oil derivatives or the like, plasticizers such as phthalic acid or sebacic acid esters, stabilizers, antistatic agents, thickening agents, flexibilizers, catalytic curing agents, rheological additives, wetting agents, coloring additives, such as dyes, or particularly pigments for different staining of components for better control of their mixing, for example, or the like, or mixtures of two or more thereof. Non-reactive diluents (solvents), such as lower-alkyl ketones, e.g. acetone, di-lower alkyl-lower-alkanoylamides, such as dimethylacetamide, lower-alkyl benzenes such as xylenes or toluene, phthalic acid esters or paraffins, or water, can be present as well, preferably in a quantity up to 30 wt %, with reference to the respective component (reaction resin mortar, curing agent), for example from 1 to 20 wt %.

A radical initiator, in particular a peroxide, is expediently used as a curing agent for the radically polymerizable compound. An accelerator can therefore also be used as an additive along with the radical initiator. This results in fast-reaction resin mortars that are cold-curing. The accelerator is conveniently stored separately from the curing agent and can be added to the resin mixture.

Suitable accelerators, which are usually added to the resin mixture, are well-known to a person skilled in the art. If peroxides are used as the curing agent, the accelerator is an amine for example, preferably a tertiary amine, and/or a metal salt.

Suitable amines are selected from the following compounds, which are, for example, described in US 2011071234 A1: dimethylamine, trimethylamine, ethylamine, diethylamine, triethylamine, n-propylamine, di-n-propylamine, tri-n-propylamine, isopropylamine, diisopropylamine, triisopropylamine, n-butylamine, isobutylamine, tert-butylamine, di-n-butylamine, diisobutylamine, triisobutylamine, pentylamine, isopentylamine, diisopentylamine, hexylamine, octylamine, dodecylamine, laurylamine, stearylamine, aminoethanol, diethanolamine, triethanolamine, aminohexanol, ethoxy aminoethane, dimethyl-(2-chloroethyl)amine, 2-ethylhexylamine, bis-(2-chloroethyl)amine, 2-ethylhexylamine, bis-(2-ethylhexyl)amine, N-methylstearylamine, dialkylamines, ethylenediamine, N,N′-dimethylethylenediamine, tetramethylethylenediamine, diethylenetriamine, permethyl diethylene triamine, triethylenetetramine, tetraethylenepentamine, 1,2-diaminopropane, dipropylene triamine, tripropylene tetramine, 1,4-diaminobutane, 1,6-diaminohexane, 4-amino-1-diethylaminopentane, 2,5-diamino-2,5-dimethylhexane, trimethylhexamethylenediamine, N,N-dimethylaminoethanol, 2-(2-diethylaminoethoxy)ethanol, bis-(2-hydroxyethyl) oleylamine, tris-[2-(2-hydroxy-ethoxy)-ethyl]amine, 3-amino-1-propanol, methyl-(3-aminopropyl) ether, ethyl-(3-aminopropyl)ether, 1 ,4-butanediol-bis-(3-aminopropyl ether), 3-dimethylamino-1-propanol, 1-amino-2-propanol , 1-diethylamino-2-propanol, diisopropanolamine, methyl-bis-(2-hydroxypropyl)amine, tris-(2-hydroxypropyl)amine, 4-amino-2-butanol, 2-amino-2-methylpropanol, 2-amino-2-methyl-propanediol, 2-amino-2-hydroxymethyl propanediol, 5-aiethylamino-2-pentanone, 3-methylamino propionic acid nitrile, 6-aminohexanoic acid, 11-aminoundecanoic acid, 6-aminohexanoic acid ethyl ester, 11 -aminohexanoic acid isopropyl ester, cyclohexylamine, N- methylcyclohexylamine, N,N-dimethylcyclohexylamine, dicyclohexylamine, N-ethylcyclohexylamine, N-(2-hydroxyethyl)-cyclohexylamine, N,N-bis-(2-hydroxyethyl)-cyclohexylamine, N-(3-aminopropyl)-cyclohexylamine, aminomethyl cyclohexane, hexahydro-toluidine, hexahydro benzylamine, aniline, N-methylaniline, N,N-dimethylaniline, N,N-diethylaniline, N,N-dipropylaniline, isobutyl aniline, toluidine, diphenylamine, hydroxyethylaniline, bis-(hydroxyethyl)aniline, chloroaniline, aminophenols, aminobenzoic acids and their esters, benzylamine, dibenzylamine, tribenzylamine, methyldibenzylamine, α-phenylethylamine, xylidine, diisopropylaniline, dodecylaniline, aminonaphthalene, N-methylaminonaphthalin, N,N-dimethylaminonaphthalene, N,N-dibenzylnaphthalene, diaminocyclohexane, 4,4′-diaminodicyclohexylmethane, diamino-dimethyl-dicyclohexylmethane, phenylenediamine, xylylenediamine, diaminobiphenyl, naphthalenediamines, toluidines, benzidines, 2,2-bis-(aminophenyl)propane, aminoanisole, aminothiophenols, aminodiphenyl ethers, aminocresols, morpholine, N-methylmorpholine, N-phenylmorpholine, hydroxyethyl morpholine, N-methylpyrrolidine, pyrrolidine, piperidine, hydroxyethyl piperidine, pyrroles, pyridines, quinolines, indoles, indolenines, carbazoles, pyrazoles, imidazoles, thiazoles, pyrimidines, quinoxalines, aminomorpholine, dimorpholine ethane, [2,2,2]-diazabicyclooctane and N, N-dimethyl-p -toluidine.

Preferred amines are aniline derivatives and N, N-bisalkylarylamines such as N,N- dimethylaniline, N,N-diethylaniline, N,N-dimethyl-p-toluidine, N,N-bis-(hydroxyalkyl)arylamines, N,N-bis-(2-hydroxyethyl)aniline, N,N-bis-(2-hydroxyethyl)toluidine, N,N-bis-(2-hydroxypropyl)aniline, N,N-bis-(2-hydroxypropyl)toluidine, N,N-bis-(3-methacryloyl-2-hydroxypropyl)-p-toluidine, N,N-dibutoxyhydroxypropyl-p-toluidine and 4,4′-bis-(dimethylamino) diphenylmethane, and their ethoxylated and/or propoxylated derivatives.

Polymeric amines, such as those obtained via the polycondensation of N,N-bis(hydroxyalkyl)aniline with dicarboxylic acids, or via the polyaddition of ethylene oxide to these amines, are suitable accelerators as well.

Cobalt octoate or cobalt naphthenate, as well as iron-, vanadium-, potassium-, calcium-, copper-, manganese- or zirconium carboxylates, are examples of suitable metal salts.

If an accelerator is used, it is used in a quantity between 0.2 to 3 wt %, preferably 0.3 to 2 wt %, with reference to the resin mixture.

In one embodiment, the resin mixture can additionally contain an adhesion promoter. The use of an adhesion promoter improves the crosslinking of the borehole wall with the plugging compound, which increases adhesion in the cured state. This is of importance for the use of the two-component plugging compound, e.g. in diamond drilled boreholes, and increases the load values. Suitable adhesion promoters are selected from the group of silanes that are functionalized with other reactive organic groups and can be incorporated into the polymer network, and that in particular exhibit hydrolyzable groups. In this respect, we refer to the publication DE 10 2009 059 210 A1, the content of which is hereby incorporated in the application.

The reaction resin mortar according to the invention is particularly suitable as a resin component for a mortar compound that is suitable for construction purposes. The reaction resin mortar is particularly suitable as a resin component for a plugging compound for chemical securing in mineral substrates.

The reaction resin mortar can be fully contained in one component and substantially constitute it. Alternatively, the reaction resin mortar can be divided among a number of in general spatially separated components.

In order for the radically polymerizable compound, and thus the reaction resin mortar, to cure, a curing agent must be added to it shortly before use. The component that contains the curing agent preferably also contains inorganic and/or organic aggregates (curing agents), whereby the aggregates can be the same as those added to the reaction resin mortar, as well as water or other liquid auxiliary agents. The aggregates are usually fillers and/or additives. The aggregates are used in quantities between 20 to 90 wt %, preferably 50 to 80 wt %, with reference to the used curing agent.

The curing agent is usually completely contained in one component, which expediently is not the same one as that/those containing the reaction resin mortar, so that, to inhibit reaction, the curing agent is separated from the radically polymerizable compound and the other components of the reaction resin mortar that can be radically polymerized. In doing so, the curing agent also forms another component of the two or more-component mortar system. The curing agent can be divided among several components as well.

The component containing the reaction resin mortar, or the components containing the reaction resin mortar that is divided by weight or by component, is/are referred to as the resin component. The component containing the curing agent, or the components containing the curing agent that is divided by weight or by component, is /are referred to as the curing agent component.

Correspondingly, a two- or multi-component mortar system, comprising an above-described reaction resin mortar and, separated to inhibit reaction, a curing agent comprising a curing agent and inorganic and/or organic aggregates, is a further subject matter of the invention.

The mortar system is preferably packaged as a two-component mortar system, whereby the one component contains the reaction resin mortar (resin component) and the other component contains the curing agent (curing agent component). The two components are expediently disposed separately to inhibit reaction.

Curing is preferably initiated with an inorganic or organic peroxide as the curing agent. All peroxides, familiar to a person skilled in the art and used for the curing of unsaturated polyester resins and vinyl ester resins can be used. Such peroxides include organic and inorganic peroxides, either liquid or solid, whereby hydrogen peroxide can be used as well.

Examples of suitable peroxides are peroxycarbonates (with the formula —OC(O)O—), peroxyesters (with the formula —C(O)OO—), diacyl peroxides (with the formula —C(O)OOC(O)—), dialkyl peroxides (with the formula —OO—) and the like. These can be present as an oligomer or as a polymer. A comprehensive series of examples for suitable peroxides is described, for example, in US 2002/0091214 A1, paragraph [0018].

The peroxides are preferably selected from the group of organic peroxides. Suitable organic peroxides are: tertiary alkyl hydroperoxides, such as tert-butyl hydroperoxide, and other hydroperoxides, such as cumene hydroperoxide, peroxyesters or peracids, such as tert-butyl perester, benzoyl peroxide, peracetates and perbenzoates, lauryl peroxide, including (di) peroxyester, perethers such as peroxy diethyl ether, per-ketones, such as methyl ethyl ketone peroxide. The organic peroxides used as curing agents are often tertiary peresters or tertiary hydroperoxides, i.e. peroxide compounds with tertiary carbon atoms that are directly bonded to an —O—O-acyl or —OOH— group. However, mixtures of these peroxides with other peroxides can be used according to the invention as well. The peroxides can also be mixed peroxides, i.e. peroxides that exhibit two different peroxide-bearing units in one molecule. Benzoyl peroxide (BPO) is preferably used for curing.

For the two- or multi-component mortar system according to the invention, the curing agent component can expediently contain the peroxide in a quantity from 0.1 to 3 wt %, and preferably from 0.25 to 2 wt %, with reference to the total weight of the two- or multi-component mortar system, i.e. the reaction resin mortar and the curing agent.

If the curing of the radically polymerizable compound is accelerated by an accelerator, this accelerator is expediently added to the reaction resin mortar. In the two- or multi-component mortar system, the reaction resin mortar can contain the accelerator in a quantity from 0.1 to 1.5 wt %, and preferably from 0.25 to 1.0 wt %, with reference to the total weight of the two- or multi-component mortar system.

The reaction resin mortar expediently contains the inhibitor as well. In the two- or multi-component mortar system, the reaction resin mortar can contain the inhibitor in a quantity from 0.003 to 0.35 wt %, and preferably from 0.01 to 0.2 wt %, with reference to the total weight of the two- or multi-component mortar system. It should be noted, that the other inhibitors that have potentially been added to the resin master batch, or to stabilize the resin mixture, must be included in the calculation of the quantity, so that the total quantity of inhibitor lies within the specified range.

With reference to the total weight of reaction resin mortar and curing agent, conventional mortar compounds contain 1.5 to 3 wt % curing agent; preferably a peroxide, and more preferably dibenzoyl peroxide (BPO). Depending on the mixing ratio, the curing agent has to include 7 to 15% of the peroxide. This leads to the labeling of the curing agent as “sensitizing”. Curing agents with a BPO content below 1% are unlabeled.

If, in accordance with a preferred embodiment of the two- or multi-component mortar system, an unlabeled system with this low peroxide concentration is to be provided and formulated, the concentrations of accelerator and inhibitor are to be reduced significantly. The concentrations for the accelerator are in the range from 0.1 to 0.5 wt %, and for the inhibitor in the range from 0.003 to 0.07 wt %. In this case the quantity specifications in “wt %” are with reference to the total weight of the two- or multi-component mortar system.

Accordingly, a preferred embodiment of the invention concerns a two- or multi-component mortar system, whereby the accelerator is contained in a quantity from 0.1 to 0.5 wt %, the inhibitor in a quantity from 0.003 to 0.07 wt % and the curing agent in a quantity from 0.1 to 0.35 wt %, each with reference to the total weight of the two- or multi-component mortar system.

Therefore, at a peroxide content of 0.25 wt % with reference to the total weight of reaction resin mortar and curing agent, at a mixing ratio of reaction resin mortar to curing agent of 3:1 parts by weight, at an inhibitor content of 0.07 wt %, for example, gel times at 25° C. can be set to 2.5 to 6 minutes by varying the accelerator content of 0.35 wt % ±25%.

At an accelerator concentration of more than 0.5 wt % at the given peroxide concentration of 0.25 wt %, it has been found that the named gel time for two- or multi-component mortars of the type under consideration cannot be set with inhibitors, because at the necessary elevated inhibitor concentrations the formulations no longer cure reliably.

However, with the two- or multi-component mortar compound according to the invention it is possible to avoid not only the labeling of the peroxide content, but also to provide a mortar compound, which at a broad mixing ratio of reaction resin mortar to curing agent in the range from 3:1 to 5:1 parts by weight allows the achievement of good curing and high load values along with ample processing time.

In a preferred embodiment of the two-component mortar system, the resin component contains a hydraulically hardening or polycondensable inorganic compound in addition to the reaction resin mortar, and the curing agent component contains water in addition to the curing agent. Such mortar compounds are described in detail in DE 42 31 161 A1. The resin component preferably contains cement as the hydraulically hardening or polycondensable inorganic compound; for example Portland cement or aluminate cement, whereby iron oxide-free or low iron oxide cements are particularly preferred. Gypsum, as such or in a mixture with the cement, can also be used as the hydraulically hardening inorganic compound. Siliceous, polycondensable compounds, in particular soluble, dissolved and/or amorphous silica-containing materials can also be used as the polycondensable inorganic compound.

In a particularly preferred embodiment of the two-component mortar compound, the resin component contains 8 to 25 wt % radically polymerizable resin, 8 to 25 wt % reactive diluent, 0.1 to 0.5 wt % accelerator and 0.003 to 0.07 wt % inhibitor, 40 to 70 wt % filler and 0.5 to 5 wt % thickening agent, and the curing agent component contains 0.1 to 0.35 wt % peroxide, 3 to 15 wt % water, 5 to 25 wt % filler and 0.1 to 3 wt % thickening agent, in each case with reference to the total weight of the two-component mortar system.

The subject matter of the invention is furthermore the use of the two- or multi-component mortar system for construction purposes.

In the sense of the present invention, the term “for construction purposes” includes the construction adhesion of concrete/concrete, steel/concrete or steel/steel, or one of the mentioned materials to other mineral materials; the structural reinforcement of building components made of concrete, masonry and other mineral materials; the armoring of buildings with fiber-reinforced polymers; the chemical securing on surfaces made of concrete, steel or other mineral materials, in particular the chemical securing of construction elements and anchoring means, such as anchor rods, anchor bolts, (threaded) rods, (threaded) bushings, reinforcing bars, bolts and like in boreholes in various substrates, such as (ferro) concrete, masonry, other mineral materials, metals (e.g., steel), ceramics, plastics, glass and wood.

The two- or multi-component mortar system according to the invention is most particularly suited for the chemical securing of construction elements and anchoring means in mineral substrates, such as concrete, masonry (solid brick or solid masonry), hollow masonry (hollow bricks or perforated brick masonry), lightweight or porous concrete, in particular concrete and brick.

### DESIGN EXAMPLES

### Examples 1 to 29 and Comparative Examples V1 to V8

Resin mixtures with the compositions shown in Tables 1 to 6 were prepared by homogeneously mixing the ingredients together. The quantities are given as parts by weight.

To prepare the reaction resin mortar compounds, 50 parts by weight of the resulting resin mixtures were homogeneously mixed with 4 parts by weight fumed silica, 15 parts by weight alumina cement and 31 parts by weight silica sand. The resin components were thus obtained.

A mixture of 1 part by weight dibenzoyl peroxide, 28 parts by weight water, 4 parts by weight fumed silica, 63 parts by weight quartz (0-80 μm) and 4 parts by weight alumina was used as the curing component.

The resin component and the curing component were mixed together in a weight ratio of 3:1, and the gel times, and the failure loads of the resulting compounds in masonry brick, were determined.

Determination of the Gel Times of the Mortar Compounds

The determination of the gel times of the mortar compounds obtained in this manner is carried out with a commercially available device (GELNORM® Gel Timer) at a temperature of 25° C. To do this the components are mixed, warmed to 25° C. in the silicone bath immediately after mixing, and the temperature of the sample is measured. The sample itself is in a test tube that is placed into an air jacket recessed in the silicone bath for warming.

The temperature of the sample is plotted against time. The analysis is conducted according to DIN16945, Sheet 1 and DIN 16916. The pot life is the time in which a temperature increase of approximately 10K is achieved, in this case from 25° C. to 35° C.

The results of the gel time determinations are listed in the following Tables 1 to 6.

Determination of the Failure Loads

M10 threaded rod anchors, which with the reaction resin mortar compounds of the examples and comparative examples are plugged into bore holes in bricks analogous to EN 791-1, but with a compressive strength of approximately 35 MPa with a diameter of 12 mm and a borehole depth of 80 mm, are used to determine the failure bond stresses of the cured compound. The average failure loads are determined by centrically pulling out the threaded anchor rods. Three threaded anchor rods at a time are plugged in, and their load values are determined after curing for 24 hours.

The failure loads (kN) determined in this manner are listed as a mean value in the following Tables 1 to 6.

Measuring the Viscosity of the Resin Mixtures

The viscosity of the resin mixtures was measured, in accordance with DIN EN ISO 2884, with a rheometer RS 600 of the Company Haake, Karlsruhe, a measurement geometry cone and plate 0 60 mm, 1° titanium (C60/1° Ti), gap 0.052 mm at a temperature of 23° C. and a shear rate of 150 s⁻¹.

TABLE 1
Composition of the resin mixtures, gel times and failure loads

| | Example | | | | | |
|---|---|---|---|---|---|---|
| | V1 ^{a)} | 1 | 2 | 3 | 4 | 5 |
| UMA Resin ^{b)} | 38 | 43 | 50 | 52 | 53.5 | 55 |
| Bis(hydroxyethyl)- | 1.5 | 1.5 | 1.5 | 1.5 | 1.5 | 1.5 |
| p-toluidine | | | | | | |
| 4-tert.- | 0.05 | 0.055 | 0.055 | 0.06 | 0.06 | 0.06 |
| butylcatechol | | | | | | |
| 1,4-butanediol | ad 100 | ad 100 | ad 100 | ad 100 | ad 100 | ad 100 |
| dimethacrylate | | | | | | |
| Resin viscosity | 138 | 217 | 348 | 478 | 590 | 745 |
| [mPa-s] | | | | | | |
| Gel time 25° C. | 4.8 | 6.2 | 5.9 | 5.2 | 5.4 | 5.1 |
| [min] | | | | | | |
| Failure load in the | 8.4 | 9.4 | 13.9 | 14.1 | 14.2 | 14.2 |
| masonry brick | | | | | | |
| M10*80 mm [kN] | | | | | | |

^{a)} V = comparative example
^{b)} Urethane methacrylate resin, prepared according to DE 411 1828 A1

TABLE 2
Composition of the resin mixtures, gel times and failure loads

| | Example | | | | | | | | |
|---|---|---|---|---|---|---|---|---|---|
| | V2 | V3 | V4 | V5 | V6 | 6 | 7 | 8 | 9 |
| UMA Resin | | 38 | 38 | 38 | 38 | 42.7 | 46 | 50 | 50 |
| Bisphenol A glycerolate | 38 | | | | | | | | |
| dimethacrylate | | | | | | | | | |
| 2- | 10 | | 10 | 10 | 25 | 10 | 10 | 10 | 10 |
| (methacryloyloxy)ethyl | | | | | | | | | |
| acetoacetate | | | | | | | | | |
| Tris(acetoacetate)- | | 5 | | | | | | | |
| trimethylolpropane | | | | | | | | | |
| Bis(hydroxyethyl)-p- | 1.5 | 1.5 | 1.5 | 1.5 | 1.5 | 1.5 | 1.5 | 1.5 | 1.5 |
| toluidine | | | | | | | | | |
| 4-tert.-butyl | 0.025 | 0.06 | 0.055 | 0.06 | 0.06 | 0.057 | 0.032 | 0.066 | 0.06 |
| butylcatechol | | | | | | | | | |
| 1,4-butanediol | ad 100 | ad 100 | ad 100 | ad 100 | ad 100 | ad 100 | ad 100 | ad 100 | ad 100 |
| dimethacrylate | | | | | | | | | |
| Resin viscosity [mPa-s] | 145 | 148 | 152 | 155 | 160 | 212 | 293 | 358 | 366 |
| Gel time 25° C. [min] | 5.6 | 4.4 | 3.9 | 5.0 | 5.4 | 3.7 | 3.6 | 3.6 | 4.4 |
| Failure load in the | 9.9 | 9.3 | 7.9 | 7.1 | 6.6 | 10.9 | 15.5 | 15.8 | 16.1 |
| masonry brick | | | | | | | | | |
| M10*80 mm [kN] | | | | | | | | | |

TABLE 3
Composition of the resin mixtures, gel times and failure loads

| | Example | | |
|---|---|---|---|
| | V7 | 10 | 11 |
| UMA Resin | 38 | 50 | 52 |
| Bis(hydroxyethyl)-p- | 1.5 | 1.5 | 1.5 |
| toluidine | | | |
| 4-Hydroxy-TEMPO ^{c)} | 0.1 | 0.11 | 0.12 |
| 1,4-butanediol | ad 100 | ad 100 | ad 100 |
| dimethacrylate | | | |
| Resin viscosity [mPa-s] | 163 | 345 | 478 |
| Gel time 25° C. [min] | 4.3 | 4.0 | 4.4 |
| Failure load in the | 7.2 | 12.8 | 18.1 |
| masonry brick | | | |
| M10*80 mm [kN] | | | |

^{c)} TEMPO = 2,2,6,6-tetramethylpiperidine-1-oxyl

TABLE 4
Composition of the resin mixtures, gel times and failure loads

| | Example | | | | | | | |
|---|---|---|---|---|---|---|---|---|
| | V8 | 12 | 13 | 14 | 15 | 16 | 17 | 18 |
| UMA Resin | 38 | 42 | | | 50 | 50 | 50 | 50 |
| Bisphenol A | | | | 50 | | | | |
| glycerolate | | | | | | | | |
| dimethacrylate | | | | | | | | |
| Sartomer SR 348C ^{d)} | | | 75 | | | | | |
| 2- | 10 | 10 | 8 | 8 | 2 | 10 | 10 | 8 |
| (methacryloyloxy)ethyl | | | | | | | | |
| acetoacetate | | | | | | | | |
| Bis(hydroxyethyl)-p- | 1.5 | 1.5 | 1.5 | 1.5 | 1.5 | 1.5 | 1.5 | 1.5 |
| toluidine | | | | | | | | |
| 4-Hydroxy-TEMPO⁾ | 0.11 | 0.12 | 0.06 | 0.08 | 0.1 | 0.13 | 0.13 | 0.14 |
| 1,4-butanediol | ad 100 | ad 100 | ad 100 | ad 100 | ad 100 | ad 100 | ad 100 | ad 100 |
| dimethacrylate | | | | | | | | |
| Resin viscosity [mPa-s] | 154 | 224 | 336 | 340 | 345 | 350 | 358 | 360 |
| Gel time 25° C. [min] | 5.5 | 3.5 | 4.8 | 4.7 | 4.4 | 4.2 | 4.2 | 4.6 |
| Failure load in the | 7.6 | 17.7 | 26.8 | 24.3 | 20.1 | 25.8 | 25.8 | 23.4 |
| masonry brick | | | | | | | | |
| M10*80 mm [kN] | | | | | | | | |

^{d)} ethoxylated bisphenol-A-dimethacrylate

TABLE 5
Composition of the resin mixtures, gel times and failure loads

| | Example | | | | |
|---|---|---|---|---|---|
| | 19 | 20 | 21 | 22 | 23 |
| UMA Resin | 50 | 50 | 50 | 50 | 50 |
| Acetoacetone | | 6 | | | |
| Benzyl acetoacetate | | | 8 | | |
| 2- | | | | | 10 |
| (methacryloyloxy)ethyl | | | | | |
| acetoacetate | | | | | |
| Tris(acetoacetate)- | 4 | | | | |
| trimethylolpropane | | | | | |
| 2-acetyl-y- | | | | 6 | |
| butyrolactone | | | | | |
| Bis(hydroxyethyl)-p- | 1.5 | 1.5 | 1.5 | 1.5 | 1.5 |
| toluidine | | | | | |
| 4-Hydroxy-TEMPO⁾ | 0.12 | 0.13 | 0.13 | 0.13 | 0.13 |
| 1,4-butanediol | ad 100 | ad 100 | ad 100 | ad 100 | ad 100 |
| dimethacrylate | | | | | |
| Resin viscosity [mPa-s] | 335 | 338 | 347 | 347 | 358 |
| Gel time 25° C. [min] | 5.4 | 5.0 | 5.2 | 4.2 | 4.2 |
| Failure load in the | 22.2 | 21.7 | 17.9 | 23.6 | 25.8 |
| masonry brick | | | | | |
| M10*80 mm [kN] | | | | | |

TABLE 6
Composition of the resin mixtures, gel times and failure loads

| | Example | | | | | |
|---|---|---|---|---|---|---|
| | 24 | 25 | 26 | 27 | 28 | 29 |
| UMA Resin | 50 | 50 | 50 | 50 | 50 | 50 |
| 2-(methacryloyloxy)ethyl | 10 | 10 | 10 | 10 | 10 | 10 |
| acetoacetate | | | | | | |
| Bis(hydroxyethyl)-p-toluidine | 1.5 | 1.5 | 1.5 | 1.5 | 1.5 | 1.5 |
| Catechol | 0.07 | | | | | |
| Inhibitor 1 ^{e)} | | 0.13 | | | | |
| Inhibitor 2 ^{f)} | | | 0.12 | | | |
| Inhibitor 3 ^{g)} | | | | 0.15 | | |
| Inhibitor 4 ^{h)} | | | | | 0.28 | |
| 4-hydroxy-3,5-di-tert- | | | | | | 0.07 |
| butyltoluene | | | | | | |
| 1,4-butanediol | ad 100 | ad 100 | ad 100 | ad 100 | ad 100 | ad 100 |
| dimethacrylate | | | | | | |
| Resin viscosity [mPa-s] | 358 | 358 | 358 | 358 | 358 | 358 |
| Gel time 25° C. [min] | 4.0 | 4.2 | 3.9 | 4.5 | 4.1 | 3.6 |
| Failure load in the | 14.7 | 25.8 | 25.4 | 24.6 | 31.9 | 22.7 |
| masonry brick | | | | | | |
| M10*80 mm [kN] | | | | | | |

^{e)} 4-hydroxy-TEMPO
^{f)} 4-phenacylidene-2,2,5,5-tetramethyl-imidazolidine-1-yloxy
^{g)} 2,3-dihydro-2,2-diphenyl-3-(phenylimino)-1H-indol-1-oxylnitroxide
^{h)} 1-(diethoxyphosphinyl)-2,2-dimethylpropyl-1,1-dimethylmethyl-nitroxide

From the above tables it can be seen that the compounds according to the invention provide significantly better failure loads than the compounds that were prepared according to the comparative examples.

1. A reaction resin mortar comprising
a resin mixture, which contains at least one radically curable compound, at least one reactive diluent and at least one inhibitor, and
at least one inorganic and/or organic aggregate,
wherein the resin mixture has a viscosity in the range between 200 and 800 mPa-s, measured according to DIN EN ISO 2884 at 23° C.

2. A reaction resin mortar of claim 1 wherein the at least one reactive diluent is selected from 1,3-dicarbonyl compounds of the general Formula (I) 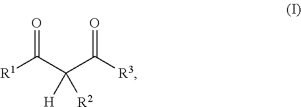
in which
R¹ is a straight-chain or branched, optionally substituted, C₁-C₆-alkyl group, preferably a C₁-C₂-alkyl group;
R³ is hydrogen or a straight-chain or branched, optionally substituted, C₁-C₆-alkyl group, a C₁-C6-alkoxy group or a methacryloyloxy of the Formula (II) 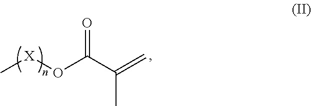
in which X is a methylene, ethylene glycol or propylene glycol group, and n is a whole number with a value from 1 up to and including 6;
R² is hydrogen, a straight-chain or branched, likewise substituted, C₁-C₆-alkyl group or a C₁-C6-alkoxy group, or together with R³ forms an optionally substituted, five- or six-membered aliphatic ring, which optionally comprises heteroatoms in or on the ring;
or of the general Formula (Ill) 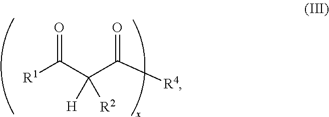
in which
R⁴ is a di- or polyhydric alcohol
x is a number between 1 and 6, and
R¹ and R² are as defined above.

3. A reaction resin mortar of claim 2 wherein the at least one reactive diluent is selected from the group consisting of acetylacetone, 2-(acetoacetoxy)ethyl methacrylate, tri methylolpropane triacetoacetate, benzyl acetoacetate, α-acetyl-γ-butyrolactone, tert-butyl acetoacetate and ethyl acetoacetate.

4. A reaction resin mortar of claim 1 wherein the at least one reactive diluent is contained in a quantity from 1 to 15 wt %.

5. A reaction resin mortar of claim 1 wherein the at least one inhibitor is selected from among the stable N-oxyl radicals or 4-hydroxy-3,5-di-tert-butyltoluenes.

6. A reaction resin mortar of claim 5 wherein the inhibitor is selected from the group consisting of piperidinyl-N-oxyl-, tetrahydropyrrole-N-oxyl-, indoline-N-oxyl-, β-phosphorylated N-oxyl radicals and 4-hydroxy-3,5-di-tert-butyltoluene.

7. A reaction resin mortar of claim 5 wherein the at least one inhibitor is contained in a quantity from 0.005 to 2 wt %.

8. A reaction resin mortar of claim 2 wherein the at least one inhibitor is selected from among the stable N-oxyl radicals or 4-hydroxy-3,5-di-tert-butyltoluenes and whereby the ratio of the at least one 1,3-dicarbonyl compound and the at least one N-oxyl radical or 4-hydroxy-3,5 di-tert-butyltoluene is between 30:1 and 150:1.

9. A reaction resin mortar of claim 1 wherein the radically polymerizable compound is an unsaturated polyester resin, a vinyl ester resin, a urethane (meth)acrylate resin and/or an epoxy(meth)acrylate resin.

10. A reaction resin mortar of claim 1 wherein the aggregate is an inorganic filler selected from the group consisting of quartz, sand, fumed silica, corundum, chalk, talc, ceramic, alumina, glass, cement, light spar and/or heavy spar in a suitable particle size distribution, or combinations thereof.

11. A reaction resin mortar of claim 1 wherein the aggregate is a thickening agent selected from the group consisting of fumed silicas, phyllosilicates, acrylate or polyurethane thickeners, castor oil derivatives, Neuburg Siliceous Earth and xanthan gum, or combinations thereof.

12. A two- or multi-component mortar system comprising a reaction resin mortar according to claim 1 and a curing agent wherein the curing agent and inorganic and/or organic aggregates are separated to inhibit reaction.

13. A two- or multi-component mortar system of claim 12 wherein the curing agent is an inorganic or organic peroxide.

14. A two- or multi-component mortar system of claim 12 further comprising an accelerator wherein the accelerator is contained in a quantity between 0.1 to 1.5 wt %, the inhibitor is contained in a quantity between 0.003 to 0.35 wt % and the curing agent is contained in a quantity between 0.1 to 3 wt %, based respectively on the total weight of the two- or multi-component mortar system.

15. A two- or multi-component mortar system of claim 14 the accelerator is contained in a quantity between 0.1 to 0.5 wt %, the inhibitor is contained in a quantity between 0.003 to 0.07 wt % and the curing agent is contained in a quantity between 0.1 to 0.35 wt %, based respectively on the total weight of the two- or multi-component mortar system.

16. Use of a reaction resin mortar for construction purposes comprising:
providing a reaction resin mortar comprising
a resin mixture, which contains at least one radically curable compound, at least one reactive diluent and at least one inhibitor, and
at least one inorganic and/or organic aggregate,
wherein the resin mixture has a viscosity in the range between 200 and 800 mPa-s, measured according to DIN EN ISO 2884 at 23° C.;
applying the reaction resin mortar said substrate;
applying the reaction resin mortar to a first substrate, and applying a second substrate to the reaction resin mortar.

17. Use of a reaction resin mortar of claim 16 for chemical securing of fastening elements and/or anchoring means in boreholes in mineral substrates.
